(19) United States
(12) Patent Application Publication
(10) Pub. No.: US 2015/0175034 A1
(43) Pub. Date: Jun. 25, 2015

(54) VEHICLE SEAT EXTENSION DEVICE

(71) Applicant: Benjamin TULLY, Mudgeeraba, Queensland (AU)

(72) Inventor: Benjamin Tully, Mudgeeraba (AU)

(21) Appl. No.: 14/391,163

(22) PCT Filed: Nov. 2, 2012
(86) PCT No.: PCT/AU2012/001343

§ 371 Date: Oct. 7, 2014

(30) Foreign Application Priority Data
Nov. 2, 2011 (AU) 2011904556

(51) Int. Cl. B60N 2/24; A61G 7/10; B60N 2/44

(52) U.S. Cl. CPC B60N 2/245; B60N 2/449; A61G 7/1025

(57) ABSTRACT

A vehicle seat extension device including an extension seat surface adapted to form a substantially continuous extension of the vehicle seat when properly fitted, a side rail engagement portion with a lower portion adapted to at least partially receive and releaseably engage a side rail and a door pillar abutment portion to at least abut an inner surface of the door pillar and prevent rotation of the device outwardly away from the vehicle seat during use.

### FIELD OF THE INVENTION

The present invention relates to generally to transfer seats and particularly to transfer to assist persons of reduced capacity to enter and exit a vehicle.

### BACKGROUND ART

The concept of transfer seats is known in the art. There are a variety of forms of transfer seat conventionally available. Examples of transfer seats include the following:
1. Portable Rotatable transfer seats—these are basically a pair of disks which are rotatable relative to one another. One disc is placed on the vehicle seat and the second disc rotates above it such that a person can sit on the second disc and when entering and exiting the vehicle, can rotate more easily between the seated position and a position in which their legs are outside the vehicle. Portable Rotatable transfer seats are typically not fixed to the vehicle seat and rely on a high friction surface on the lower side of the first disc in order to maintain their position on the vehicle seat.
2. Fixed rotatable transfer seats—these are typically a specifically designed vehicle seat which is fixed into a vehicle on a base fixed to the vehicle chassis and the entire seat is movable between a position in which the person faces forwardly and an entry and exit position in which the seat typically moves longitudinally backwards and also rotates relative to the vehicle. These are particularly complex and require removal of the existing vehicle seats in order to be fitted. They also fitted permanently to the vehicle.
3. Folding transfer seats—these devices are typically bolted through the floor to brackets to which a guide rail is fitted and to which, a removable or foldable seat can be fitted. Once fitted, the device is typically attached permanently and is simply folded between a use condition in which it is substantially parallel to the vehicle seat and a storage condition in which it is substantially vertical and positioned beside the vehicle seat. This device limits mobility when in the storage condition as it typically extends upwardly above the surface of the vehicle seat and can therefore impede access to seat belts, seat controls and other controls which are located beside the seat.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a vehicle seat extension device, which may at least partially overcome at least one of the abovementioned disadvantages or provide the consumer with a useful or commercial choice.

With the foregoing in view, the present invention in one form, resides broadly in a vehicle seat extension device including an extension seat surface adapted to form a substantially continuous extension of the vehicle seat when properly fitted, a side rail engagement portion with a lower portion adapted to at least partially receive and releaseably engage a side rail and a door pillar abutment portion to at least abut an inner surface of the door pillar and prevent rotation of the device outwardly away from the vehicle seat during use.

The device of the present invention is typically adapted to be inserted into the vehicle and temporarily wedged (or otherwise secured) into position to allow a user of limited mobility to be transferred or transfer themselves more easily into and out of the vehicle.

The vehicle seat extension device of the present invention includes a seat surface adapted to form a substantially continuous extension of the vehicle seat when properly fitted. The seat surface will normally be an upper surface of the device in use. The seat surface may be padded or contoured for the purposes of comfort.

It is particularly preferred that the seat surface may be a low friction surface in order to allow a user seated on the vehicle seat to slide across the seat surface during entry to and exit from the vehicle.

The seat surface will normally be substantially horizontal when properly fitted.

The seat surface will normally be spaced above the vehicle door rail in order to locate the seat surface in substantially the same plane as the upper surface of the vehicle seat.

The seat surface will typically be wide enough to extend the vehicle seat at least to or outside the plane of the vehicle door rail. This will preferably increase the ease with which a person can enter or exit the vehicle.

The device will therefore typically require the vehicle door to be open in order to fit the device to the vehicle. Further, the door preferably not be able to be closed while the device is fitted. Alternative versions may exist including foldaway portions of the seat surface which may allow the device to remain fitted but to have a deployable portion to extend at least to or outside the plane of the vehicle door rail.

The inner edge of the seat surface will typically be shaped in order to match or correspond to the shape of the side edge of the vehicle seat. Further, the seat surface will typically be as long from front to back as the seat is deep, in order to provide a full-length extension of the vehicle seat.

A rear portion of the seat surface will preferably be forked or toed with an inner extension portion and an outer extension portion.

The seat surface may be formed of any material or combination of materials but typically, the seat surface is formed by providing a structural member with a padded portion over the structural member and a low friction cover provided over the padded portion.

The vehicle seat extension device of the present invention includes a side rail engagement portion with a lower portion adapted to at least partially receive a door side rail therebetween.

Typically, there will be at least one, and preferably, a pair of members extending downwardly from an underside of the seat surface. Normally, there will be one inner member and one outer member which are each substantially parallel to the door side rail. Each of the inner and outer members will be of appropriate height to locate the seat surface at a level which is substantially coplanar with the upper surface of the vehicle seat.

According to a preferred embodiment, the inner member will typically extend further rearwardly than the outer member. The inner member will typically extend further downwardly than the outer member, that is, a lower edge of the inner member extends further downwardly than the outer member.

It is preferred that the inner member is located on one side of the vehicle door rail and the outer member is located on the outer side of the vehicle door rail. However, the outer member may be located above the door side rail in that a lower edge of the outer member may abut the upper surface of the door side rail.

Typically, the edges of the inner and outer member will be contoured to match the side rail or vehicle floor contour such that relative movement between the device of the invention and the door side rail or vehicle floor is minimised. This will preferably increase the stability of the device particularly during use.

According to a further preferred embodiment, either one or both of the inner or outer members may be provided with features that allow space for or provide access for vehicle seat operators or other vehicle operators which may be located beside the vehicle seat.

It is also preferred that either one or both of the inner or outer members may be larger in height towards the front of the device in order to prevent rotation of the device forwardly, particularly in use.

The inner and outer members will preferably be spaced from one another. One or more bracing/connecting members or arrangements may be provided between the inner and outer member in order to maintain the spacing between them.

Each of the inner and outer members will normally be substantially vertical. Further, both members will typically be strong and rigid.

The vehicle seat extension device of the present invention also includes a door pillar abutment portion to at least abut a part in the inner surface of the door pillar of vehicle and prevent rotation of the device outwardly away from the vehicle seat.

For the purpose of clarity only, pillars are the vertical supports of what is sometimes known as “the greenhouse of an automobile” and are known respectively as the A, B, C or D-pillar moving in profile view from the front to rear. In American and British English, the pillars are sometimes referred to as posts (A-post, B-post etc.). The greenhouse (or glasshouse) of a car comprises the windscreen, rear and side windows, the more or less vertical pillars separating them (designated A-pillar, B-pillar and so on, starting from the car's front), and the car's roof.

Preferably, the inner extension portion of the seat surface will typically abut an inner surface of the door pillar, normally a B-pillar if used in the front seat of a vehicle or a C-pillar if used in a rear seat. Further, a rear portion of the substantially vertical inner member will normally also abut an inner surface of the door pillar. Further still, it is preferred that during insertion of the device into position, a portion of the normally resilient vehicle seat will be deformed in order to allow fitment, and the resilient vehicle seat will then bias the extension seat against the pillar and/or door side rail. This will typically act to wedge the device in between the outer edge of the seat and the door pillar.

Typically, the door pillar will be received in the rear portion of the seat surface between the inner extension and the outer extension.

There may be additional securing means provided on the vehicle seat extension device of invention in order to hold the extension device in position in the vehicle. It is preferred that any additional securing means be quickly and easily operated to allow insertion and removal of the device in the vehicle.

One preferred securing option is an elongate strap or similar which can be either secured about the vehicle seat extension device or attached to the vehicle seat extension device. In a preferred embodiment, the vehicle seat extension device may be provided with a strip of a first attachment means to which is secured a second attachment means, with the second attachment means attached to the vehicle.

A strip of hook and eye fastener such as Velcro® may be attached to the vehicle seat extension device. A strap or similar of the corresponding attachment means is then wrapped around the base of the front seat where it is attached to the floor, then stapled to secure it to the seat bracket. Once the vehicle seat extension device is in place, the strap is then attached to the Velcro® to secure it in position. The strap then has to be released to allow removal of the access seat.

The vehicle seat extension device of a preferred embodiment will normally be formed from a number of different panels, usually planar albeit of a unique shape, that are attached to or relative to one another to form the device. According to a particularly preferred form of the invention, any one or more of the panels used to form the device can be provided with rebates in order to at least partially receive a portion of a panel which is attached via the rebate. Typically, the panels are attached to one another using an adhesive and then threaded fasteners in order to increase the strength of the device which is important, given its use. Any suitable adhesive and fasteners can be used.

Any of the features described herein can be combined in any combination with any one or more of the other features described herein within the scope of the invention.

### BRIEF DESCRIPTION OF THE DRAWINGS

Various embodiments of the invention will be described with reference to the following drawings, in which:

FIG. 1 is a top view of a vehicle seat extension device according to a preferred embodiment of the present invention.

FIG. 2 is a view from beneath of the vehicle seat extension device illustrated in FIG. 1.

FIG. 3 is a view from the front of the vehicle seat extension device illustrated in FIG. 1.

FIG. 4 is a view from the rear of the vehicle seat extension device illustrated in FIG. 1.

FIG. 5 is a view from the inside of the vehicle of a vehicle seat extension device illustrated in FIG. 1.

FIG. 6 is a view from the outside of the vehicle of a vehicle seat extension device illustrated in FIG. 1.

FIGS. 7A to 7E illustrate panels used to form a vehicle seat extension device according to a preferred embodiment of the present invention.

FIG. 8 is an axonometric image of a vehicle seat extension device of a preferred embodiment of the present invention fitted to a vehicle.

FIG. 9 is an axonometric image from the rear of the arrangement illustrated in FIG. 8.

FIG. 10 is a graphic illustration of the load versus stroke displacement in a first test on the vehicle seat extension device of a preferred embodiment.

FIG. 11 is a graphic illustration of the load versus stroke displacement in a second test on the vehicle seat extension device of a preferred embodiment.

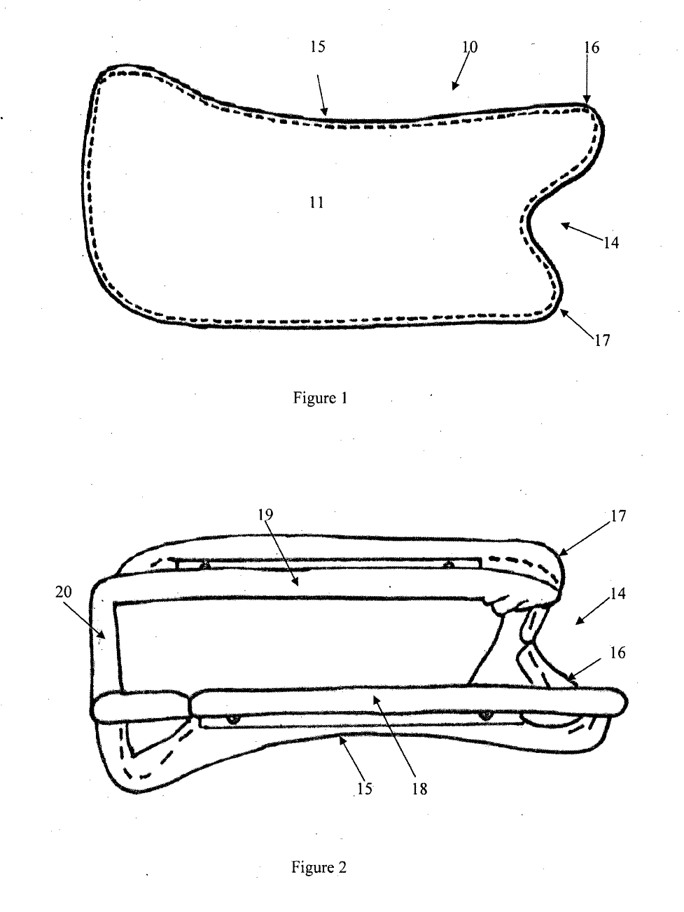

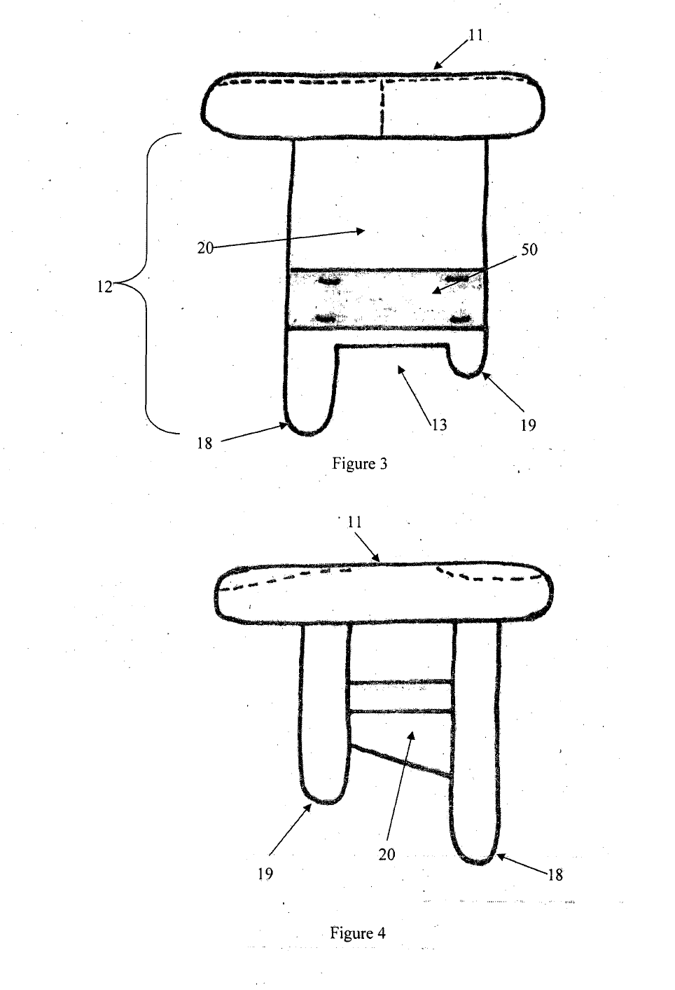

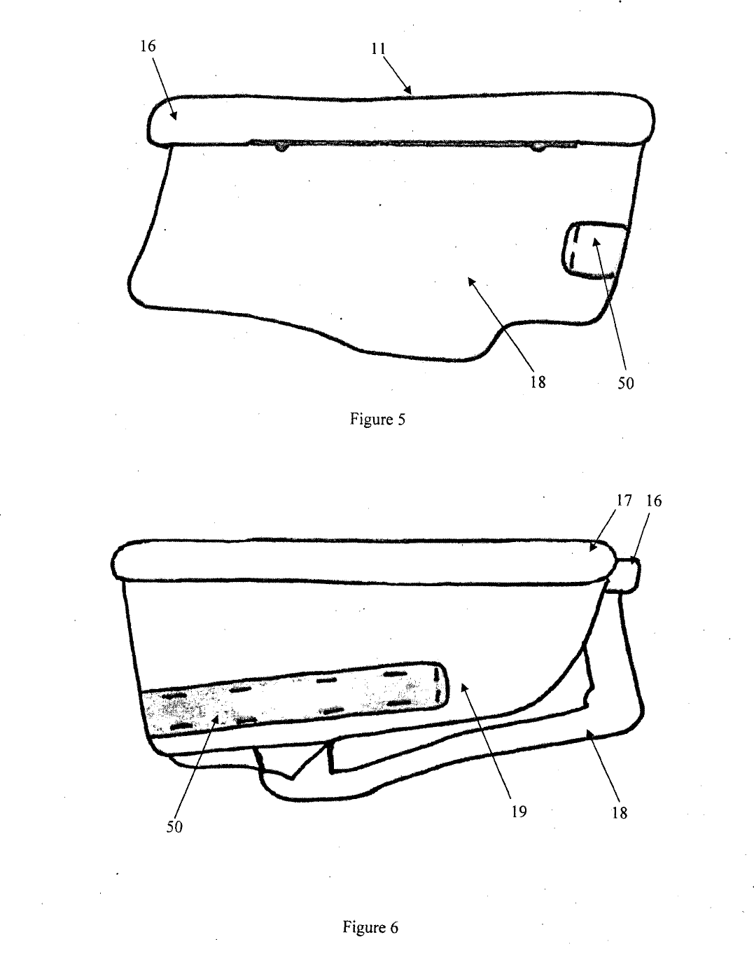

### DETAILED DESCRIPTION OF THE PREFERRED EMBODIMENT

According to a preferred embodiment, a vehicle seat extension device 10 is provided.

The vehicle seat extension device 10 illustrated in the Figures includes an extension seat surface 11 adapted to form a substantially continuous extension of a vehicle seat (not shown) when properly fitted, a side rail engagement portion 12 with a lower portion 13 adapted to at least partially receive and releaseably engage a side rail (not shown) and a door pillar abutment portion 14 to at least abut an inner surface of the door pillar (not shown) and prevent rotation of the device 10 outwardly away from the vehicle seat during use.

The seat surface 11 illustrated is adapted to form a substantially continuous extension of the vehicle seat when properly fitted and is padded or contoured for the purposes of comfort.

The seat surface is a low friction surface, such as vinyl or similar in order to allow a user seated on the vehicle seat to slide across the seat surface 11 during entry to and exit from the vehicle.

The seat surface 11 is spaced above the vehicle door rail in order to locate the seat surface in substantially the same plane as the upper surface of the vehicle seat. The seat surface is wide enough to extend the vehicle seat outside the plane of the vehicle door rail as this increases the ease with which a person can enter or exit the vehicle.

The inner edge 15 of the seat surface 11 is shaped in order to match or correspond to the shape of the side edge of the vehicle seat.

According to the embodiment illustrated, the rear portion of the seat surface 11 forms the side pillar abutment portion 14 and is forked or toed with an inner extension portion 16 and an outer extension portion 17.

A pair of members extending downwardly from an underside of the seat surface form the door rail engagement portion of the illustrated embodiment. There is an inner member 18 and an outer member 19 which are each substantially parallel to the door side rail. Each of the inner 18 and outer 19 members are of appropriate height to locate the seat surface 11 at a level which is substantially coplanar with the upper surface of the vehicle seat.

According to the embodiment illustrated, the inner member 18 extends further rearwardly than the outer member 19. The inner member 18 also extends further downwardly than the outer member 19, that is, a lower edge of the inner member 18 extends further downwardly than the outer member 19.

Typically, the edges of the inner 18 and outer 19 members are contoured to match the side rail or vehicle floor contour such that relative movement between the device and the door side rail or vehicle floor is minimised.

The inner 18 and outer 19 members are spaced from one another. One or more bracing/connecting members 20 or arrangements may be provided between the inner 18 and outer member 19 in order to maintain the spacing between them and in the embodiment illustrated, the bracing member is an end member.

Preferably, the inner extension portion 16 of the seat surface 11 abuts an inner surface of the door pillar, normally a B-pillar if used in the front seat of a vehicle or a C-pillar if used in a rear seat and the outer extension portion 17 of the seta surface 11 abuts and outer surface of the door pillar. Further, a rear portion of the substantially vertical inner member 18 will normally also abut an inner surface of the door pillar. During insertion of the device into position, a portion of the normally resilient vehicle seat will be deformed in order to allow fitment, and the resilient vehicle seat then biaes the extension seat 10 against the pillar and/or door side rail. This will typically act to wedge the device in between the outer edge of the seat and the door pillar.

An elongate strap (not shown) can be wrapped about the vehicle seat extension device or attached to the vehicle seat extension device. In the illustrated embodiment, the vehicle seat extension device is provided with a strip 50 of a Velcro® attachment means.

A strap or similar with the corresponding Velcro attachment means is then wrapped around the base of the front seat where it is attached to the floor, then stapled to secure it to the seat bracket. Once the vehicle seat extension device is in place, the strap is then attached to the Velcro® strip 50 on the vehicle seat extension device to secure it in position. The strap then has to be released to allow removal of the vehicle seat extension device.

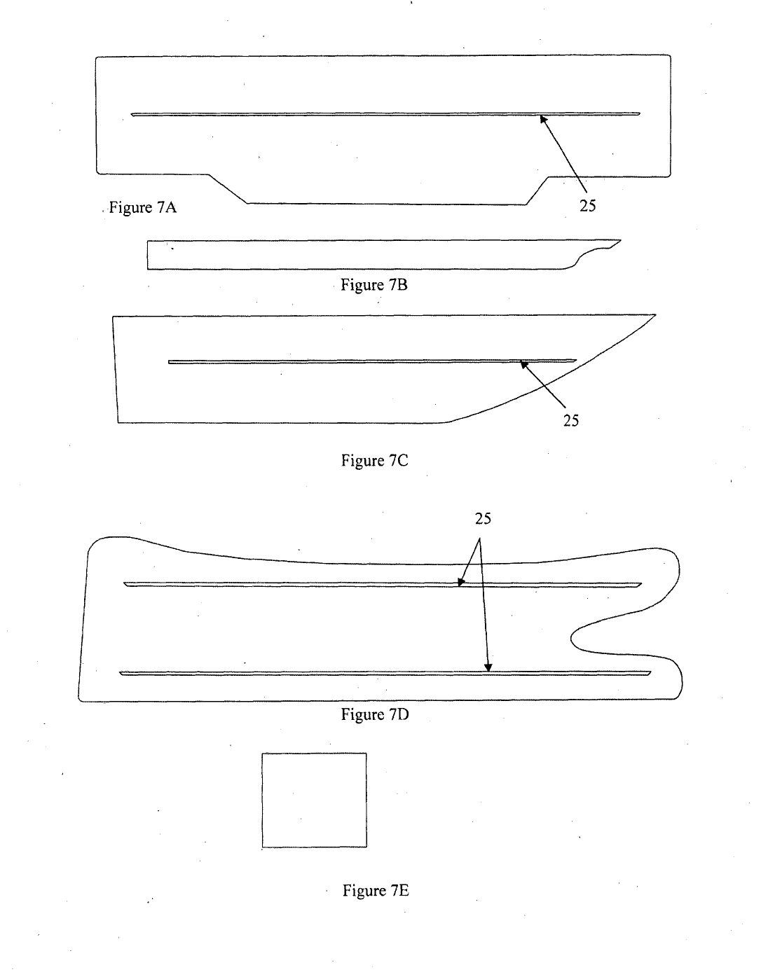

The vehicle seat extension device of the preferred embodiment is formed from a number of different panels, usually planar albeit of a unique shape, that are attached to or relative to one another to form the device. The particular panels used to create a vehicle seat extension device of a preferred embodiment are illustrated in FIGS. 7A to 7E. The panels are the inner member, a brace panel, the outer member, the top panel and the forward brace panel in order from FIG. 7A to FIG. 7E.

As illustrated, the inner member, the outer member and the top panel are all provided with at least one rebate 25 in order to receive a portion of a panel which is attached.

Typically, the panels are attached to one another using an adhesive and then threaded fasteners, that is, “glued and screwed” in order to increase the strength of the device which is important, given its use. Any suitable adhesive and fasteners can be used. The wall assembly is then provided with suitable padding, particularly on the upper or top panel and then the top panel is covered with vinyl or similar. A further advantage of covering with final is the provision of a surface that allows a person to easily slide across the device of the present invention.

Lower portions of the device are typically covered with a fabric or similar in order to provide an aesthetically pleasing appearance.

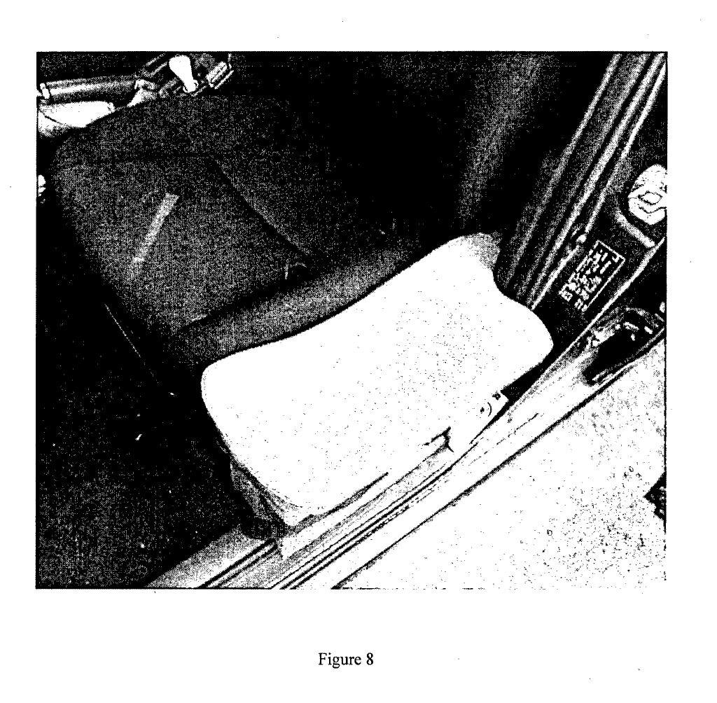

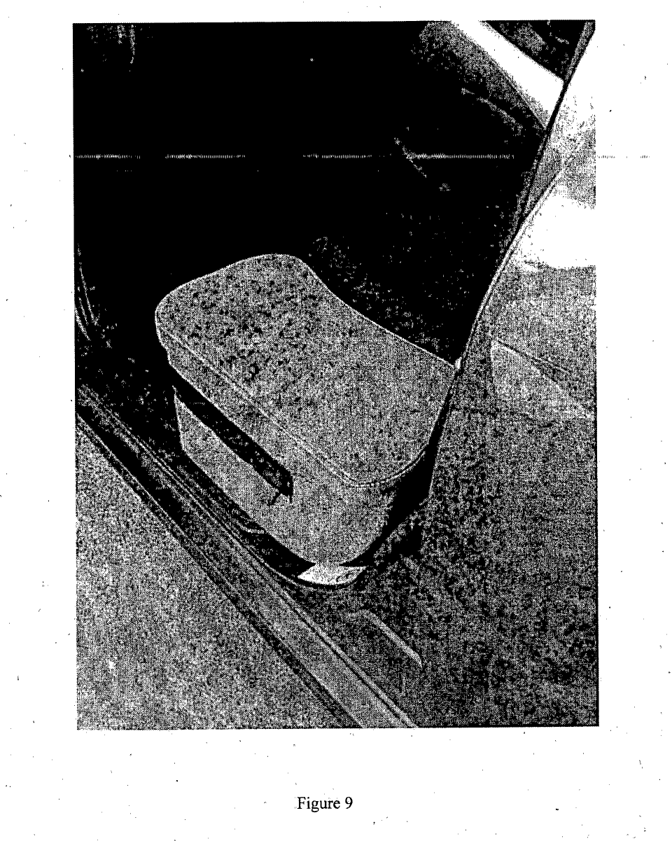

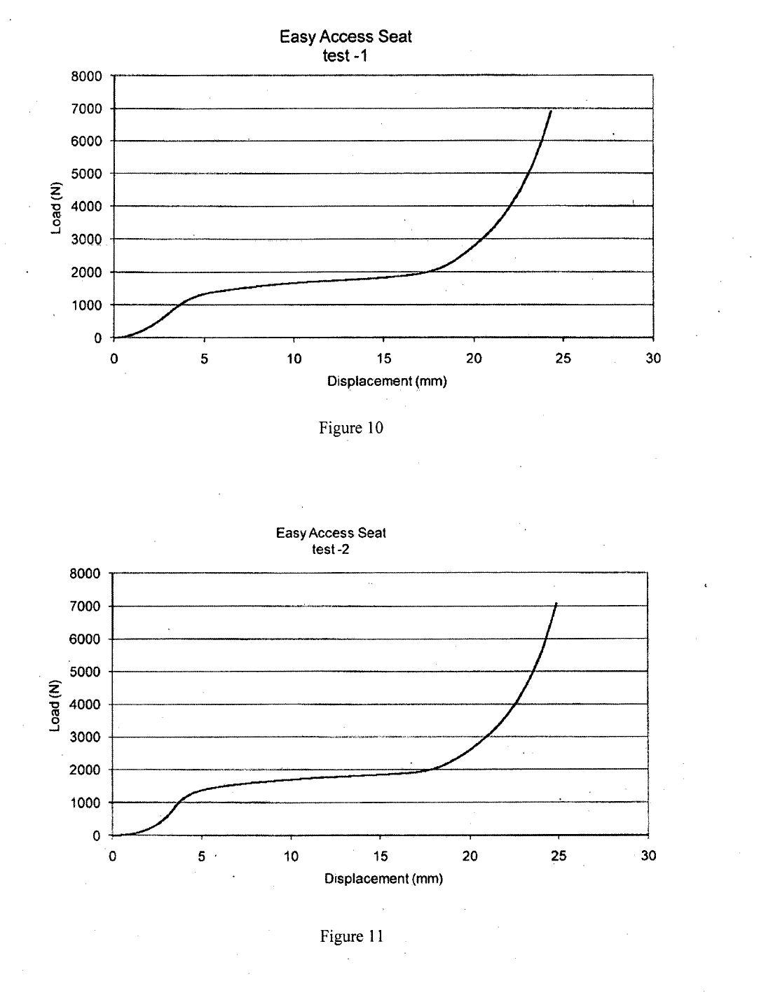

The installation of the device into a vehicle is relatively straightforward given the particular configuration of the device and an example installation is illustrated in FIGS. 8 and 9. Due to the dimensions and shape of the device, the inner member is received inside the side rail defining the door opening and the outer member is received outside the side rail defining the door opening. The door pillar abutment portion of the top panel abuts and partially receives the door pillar and be upper surface of the device is substantially coplanar with the seat to which it is adjacent.

The Velcro strap which has earlier been attached to a portion of the vehicle extends about the forward or front wall of the device and engages with the strip 50 on the outside of the outer panel member in order to hold the device closely against the seat in combination with the door pillar abutment portion which prevents rotation of the device outwardly as weight is placed on it.

The device of the present invention is particularly robust and has been the subject of static load testing to assess the load capacity of the device. The load testing was conducted by the School of Civil Engineering at the University of Sydney.

In the load testing, a mould was manufactured by the University of Sydney in order to simulate the position of the device in a vehicle. A vertical compression load was applied using an MTS Syntech machine. An S-type load cell model 6918 was used to measure the applied load.

Two prototypes of the device were tested. The results of the testing are illustrated in FIGS. 10 and 11 respectively for each of the prototype devices. According to the first test, the maximum vertical applied load was 6916 N. The device after testing showed no detriment in terms of fracture, tears, de-bonding or breakage. As indicated above, a graph of load versus stroke displacement is illustrated for the first tested device in FIG. 10.

According to the second test the device, the maximum vertical applied load was 7084 N. Again, the device after testing showed no detriment in terms of fracture, tears, de-bonding or breakage. As indicated above, a graph of load versus stroke displacement is illustrated for the second tested device in FIG. 11.

The test results are summarised in the table below:

| | Applied compression | Applied compression |
|---|---|---|
| Specimen | load (N) | load (kg) |
| 1 | 6916 | 705 |
| 2 | 7084 | 722 |
| Mean | 7000 | 713.5 |

As can be seen from this table, the average pride vertical compression load for the tested devices was 713.5 kg indicating that the device is particularly robust and capable of bearing large loads thereby complying with numerous safety requirements and standards and providing peace of mind to the users of the device.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. A vehicle seat extension device including an extension seat surface adapted to form a substantially continuous extension of the vehicle seat when properly fitted, a side rail engagement portion with a lower portion adapted to at least partially receive and releaseably engage a side rail and a door pillar abutment portion to at least abut an inner surface of the door pillar and prevent rotation of the device outwardly away from the vehicle seat during use.

2. A vehicle seat extension device as claimed in claim 1 adapted to be inserted into the vehicle and temporarily wedged into position to allow a user of limited mobility to be transferred or transfer themselves more easily into and out of the vehicle.

3. A vehicle seat extension device as claimed in claim 1 wherein the extension seat surface is a low friction surface in order to allow a user seated on the vehicle seat to slide across the seat surface during entry to and exit from the vehicle.

4. A vehicle seat extension device as claimed in claim 1 wherein the seat surface is spaced above the vehicle door rail in order to locate the seat surface in substantially the same plane as the upper surface of the vehicle seat.

5. A vehicle seat extension device as claimed in claim 1 wherein the seat surface is sufficiently wide to extend the vehicle seat at least to the plane of a vehicle door rail.

6. A vehicle seat extension device as claimed in claim 1 wherein an inner edge of the seat surface is shaped in order to correspond to the shape of an outer side edge of the vehicle seat against which the seat surface abuts.

7. A vehicle seat extension device as claimed in claim 1 wherein the seat surface is dimensioned to be as long from front to back as the vehicle seat is deep.

8. A vehicle seat extension device as claimed in claim 1 wherein a rear portion of the seat surface is shaped to be received between a portion of the vehicle seat and a substantially upright vehicle door pillar and be wedged therebetween.

9. A vehicle seat extension device as claimed in claim 8 wherein the rear portion of the seat surface is forked or toed with an inner rearward extension portion and an outer rearward extension portion.

10. A vehicle seat extension device as claimed in claim 1 including a vehicle side rail engagement portion with a lower portion adapted to at least partially receive a vehicle side rail therebetween,

11. A vehicle seat extension device as claimed in claim 10 wherein the vehicle side rail engagement portion includes a pair of members extending downwardly from an underside of the seat surface, one inner member and one outer member which are each substantially parallel to one another.

12. A vehicle seat extension device as claimed in claim 11 wherein the inner member extends further downwardly than the outer member.

13. A vehicle seat extension device as claimed in claim 11 wherein the inner member is located on one side of the vehicle side rail and the outer member is located on an outer portion of the vehicle side rail.

14. A vehicle seat extension device as claimed in claim 11 wherein a lower edge of each of the inner member and outer member are contoured to match the side rail or vehicle floor such that relative movement between the device of the invention and the door side rail or vehicle floor is minimised.

15. A vehicle seat extension device as claimed in claim 1 wherein during insertion of the device into position, a portion of a resilient vehicle seat is deformed in order to allow fitment, and the resilient vehicle seat then biases the extension seat against the vehicle door pillar and vehicle door side rail.

16. A vehicle seat extension device as claimed claim 1 further including a securing assembly provided on the vehicle seat extension device to hold the extension device in position in the vehicle.

17. A vehicle seat extension device as claimed in claim 16 wherein the securing assembly includes an elongate strap to be secured about the vehicle seat extension device or attached to the vehicle seat extension device.
